(19) United States
(12) Patent Application Publication
(10) Pub. No.: US 2026/0286209 A1
(43) Pub. Date: Sep. 24, 2026

(54) PROCESS FOR PREPARING AN OIL-WELL CEMENT SLURRY

(71) Applicants: OIL AND NATURAL GAS CORPORATION LIMITED, New Delhi (IN); RAJIV GANDHI INSTITUTE OF PETROLEUM TECHNOLOGY, Amethi (IN)

(72) Inventors: Bibhash Chandra MISHRA, Dehradun (IN); Tushar SHARMA, Amethi (IN); Suvendu SEN, Dehradun (IN); Ramaswamy GAUTAM, Amethi (IN); Abhinav HAZRA, Dehradun (IN); Ram Satish ANNAVARAPU, Dehradun (IN); Alok Kumar MISHRA, Dehradun (IN); Prashant FAUJDAR, Dehradun (IN)

(73) Assignees: OIL AND NATURAL GAS CORPORATION LIMITED, New Delhi (IN); RAJIV GANDHI INSTITUTE OF PETROLEUM TECHNOLOGY, Amethi (IN)

(21) Appl. No.: 19/571,777

(22) Filed: Mar. 19, 2026

(30) Foreign Application Priority Data
Mar. 21, 2025 (IN) 202511025898

(51) Int. Cl. C09K 8/502; C09K 8/504; C09K 8/508

(52) U.S. Cl. CPC C09K 8/502; C09K 8/5045; C09K 8/5083; C09K 2208/10

(57) ABSTRACT

A process for preparing oil-well cement slurry by hydrolysing precursor and accelerator in a medium to obtain colloidal suspension of silica nanofluid including size-controlled silica nanoparticles. A predetermined volume of precursor is added to the medium at a flow rate and an interval for every 25% incremental addition of precursor. A solvent is added dropwise after every 25% incremental addition of the predetermined volume of precursor to the medium to obtain a mixture. The mixture is heated at a predetermined temperature for a predetermined duration. The predetermined volume of accelerator is added dropwise for predetermined to duration the mixture to obtain colloidal suspension of silica nanofluid including size-controlled silica nanoparticles having a particle size ranging from 5-300 nm. An amount of water is added to silica nanofluid to obtain a base fluid. Cement is added to the base fluid at a cement to base fluid ratio of 100:45.

### FIELD

The present invention relates to the field of cement slurry used in oil and gas industry. More specifically, the present invention relates to a process for preparing an oil-well cement slurry composition comprising size-controlled silica nanoparticles.

### BACKGROUND

Oil-well cementing is a critical operation in wellbore construction considering requirements of structural integrity and longevity of oil and gas wells. Oil-well cementing involves pumping cement into the annular space between the casing and wall of a wellbore to create a durable bond. The primary objectives of oil-well cementing include providing zonal isolation and preventing fluid migration between geological formations. Additionally, it offers mechanical support to the casing, protecting it from corrosive wellbore fluids and extreme subsurface conditions.

One of the key challenges in oil-well cementing is preventing fluid loss to permeable formations, which can compromise the integrity of cementing operation. Fluid migration can lead to poor zonal isolation, casing instability, and even the loss of hydrocarbon containment, thereby significantly impacting well productivity and safety. Moreover, gas and fluid migration through the cement sheath or along the casing interface can further degrade well performance.

Another significant concern during cementing operations is shale swelling which is caused by invasion of fluids into formations containing water-absorbent clay minerals. Shale swelling weakens the wellbore structure, thereby leading to instability and affecting overall well performance. Designing an optimal cement slurry requires a careful balance of various additives to efficiently perform under high-pressure, high-temperature (HPHT) conditions commonly encountered in deep wells, which poses several technical challenges. Additionally, the ingress of formation fluids after cement placement can negatively impact porosity and permeability, further emphasizing the need for advanced cement formulations.

In recent years, incorporating nanotechnology into cement slurry has emerged as a promising approach to optimizing cement density, improving mechanical performance, and reducing porosity and permeability. Despite its advantages, the use of nanoparticles in oil well cementing presents challenges such as ensuring uniform dispersion, controlling particle size, and managing hydration kinetics. These challenges often arise from the method of incorporation, can which lead to non-uniform distribution and inconsistent particle sizes. Such uneven dispersion can negatively impact the effectiveness of nanoparticles in modifying cement properties, potentially leading to poor performance in wellbore conditions.

Further, in conventional methods of preparing oil-well cement slurries, powdered silica nanoparticles are externally mixed into the cement-water system. This conventional approach has inherent challenges related to agglomeration, poor dispersion, and lack of control over particle size. Dry silica nanoparticles have a high surface energy which causes them to clump together, thereby forming large aggregates that do not distribute evenly within the cement matrix. These agglomerated particles create inhomogeneous zones in the cement slurry, thereby leading to inconsistent mechanical properties, increased porosity, and reduced overall strength. Additionally, conventional methods do not allow precise control over nanoparticle size. That is, the particles may not effectively penetrate micro voids or form an optimal bond with the cement hydration products. Also in conventional methods, spaces between cement particles are not filled by nanoparticles due to non-uniform dispersion which result in formation of clusters which act as localized nucleation sites for hydration products.

In light of the above drawbacks, there is a need for an improved method of preparing oil-well cement slurry to enhance performance of cementing operation. Furthermore, an improved oil-well cement slurry composition is required to address fluid loss, improve mechanical properties, minimize porosity and permeability, and enhance overall operational efficiency in the oil and gas industry. There is a need for cement compositions that minimize excessive water ingress and counteract swelling effects.

### SUMMARY

In various embodiments of the present invention, a process for preparing an oil-well cement slurry is provided. The process comprises the steps of (a) hydrolysing a precursor and an accelerator in a medium to obtain a colloidal suspension of silica nanofluid comprising size-controlled silica nanoparticles. The hydrolysis comprises the steps of (1) adding a predetermined volume of the precursor to the medium at a predetermined flow rate and at a predetermined interval for every 25% incremental addition of the predetermined volume of the precursor (2) adding a solvent dropwise after every 25% incremental addition of the predetermined volume of precursor to the medium to obtain a mixture, (3) heating the mixture at a predetermined temperature for a predetermined duration, (d) adding a predetermined volume of the accelerator dropwise for a predetermined duration to the mixture to obtain a colloidal suspension of silica nanofluid comprising size-controlled silica nanoparticles having a particle size in a range from 5-300 nm. The process further comprises the step of adding a predetermined amount of water to silica nanofluid to obtain a base fluid. Further, the process comprises the step of adding cement to the base fluid at a cement to base fluid ratio of 100:45 to obtain an oil-well cement slurry comprising size-controlled silica nanoparticles.

In an embodiment of the present invention, wherein the precursor is selected from a group consisting of tetraethyl orthosilicate and sodium metasilicate nonahydrate. In an embodiment of the present invention, a concentration of tetraethyl orthosilicate is in a range from 0.14 to 0.70 mol/L. In an embodiment of the present invention, a concentration of sodium metasilicate nonahydrate is in a range from 0.16 to 0.83 mol/L.

In an embodiment of the present invention the accelerator is ammonium hydroxide, having a concentration in a range from 0.25 to 0.91 mol/L. In an embodiment of the present invention, the pre-determined volume of accelerator is in the range from 15 to 30 ml for 1000 ml nanofluid. In an embodiment of the present invention, a 25% ammonium hydroxide is used to maintain a pH in a range from 8 to 9.

In an embodiment of the present invention, the medium is a polyacrylamide solution having a concentration in a range from 200 to 1000 ppm and the solvent is ethanol. In an embodiment of the present invention, the polyacrylamide solution is prepared by adding a predetermined amount of polyacrylamide to deionized water and stirring the polyacrylamide solution in a range from 800 to 900 rpm.

In an embodiment of the present invention, the pre-determined volume of the precursor is in a range from 30 to 150 ml. The precursor is introduced at the pre-determined flow rate in a range from 0.5 to 1 ml/min and at the pre-determined interval of 15 minutes for every 25% incremental addition of the pre-determined volume. In an embodiment of the present invention, the predetermined volume of the accelerator is added dropwise for a predetermined duration of 15 minutes to the mixture.

In an embodiment of the present invention, the mixture is heated at a temperature in the range from 50° C. to 80° C. for a duration of 30 minutes.

In various embodiments of the present invention an oil-well cement slurry is provided. The oil-well cement slurry comprises cement, water, and size-controlled silica nanoparticles, wherein the size-controlled nanoparticles are synthesised by hydrolysing tetraethyl orthosilicate in a polyacrylamide solution in the presence of ammonium hydroxide, and wherein the cement to base fluid ratio is 100:45, and wherein the particle size of silica nanoparticles is in a range from 5-300 nm. In an embodiment of the present invention, the oil-well cement slurry comprising the size-controlled silica nanoparticles exhibits a high zeta potential in a range from −46 to −38 mV.

### BRIEF DESCRIPTION OF THE DRAWINGS

The present invention is described by way of embodiments illustrated in the accompanying drawings herein.

FIG. 1(a) is a scanning electron microscopy image of conventional oil-well cement slurry and FIG. 1(b) is a SEM image of oil-well cement slurry prepared in accordance an embodiment with present invention;

FIG. 2 is an illustration depicting the porosity of oil-well cement slurry prepared in accordance an embodiment with present invention;

FIG. 3a, is a graph illustrating the particle size of nanoparticles prepared in accordance an embodiment with present invention;

FIG. 3b is a graph illustrating a zeta potential distribution prepared in accordance an embodiment with present invention;

FIG. 3c is a graph illustrating a particle size of nanoparticles in accordance an embodiment with present invention;

FIG. 3d is a graph illustrating a zeta potential distribution prepared in accordance an embodiment with present invention.

### DETAILED DESCRIPTION

In an embodiment of the present invention, a process for preparing an oil-well cement slurry comprising size-controlled silica nanoparticles is provided. The present invention ensures effective reduction in porosity and permeability of cement structures in a wellbore. The present invention further reduces agglomeration of silica nanoparticles thereby achieving uniform distribution of silica nanoparticles throughout the cement slurry.

The disclosure is provided to enable a person having ordinary skill in the art to practice the invention. Exemplary embodiments herein are provided only for illustrative purposes and various modifications will be readily apparent to a person skilled in art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications, and equivalents consistent with the principles and features disclosed herein. For purposes of clarity, details relating to technical material that is known in the technical fields related to the invention have been briefly described or omitted so as not to unnecessarily obscure the present invention.

In an embodiment of the present invention, a process for preparing an oil-well cement slurry is provided. The process comprises the step of hydrolysing a precursor and an accelerator in a medium to obtain a colloidal suspension of size-controlled silica nanoparticles (silica nanofluid). In an exemplary embodiment of the present invention, the precursor is tetraethyl orthosilicate, accelerator is ammonium hydroxide, and the medium is polyacrylamide solution. In another exemplary embodiment, the precursor is sodium metasilicate nonahydrate. The process further comprises the step of adding a predetermined amount of water to the silica nanofluid to obtain a base fluid. Yet further, the process comprises the step of adding cement to base fluid at a cement to base fluid ratio of 100:45 to obtain an oil-well cement slurry with size-controlled silica nanoparticles.

### Synthesizing Silica Nanofluid

In an embodiment of the present invention, the silica size-controlled silica nanoparticles is nanofluid having synthesized by carrying out a hydrolysis reaction between tetraethyl orthosilicate, ammonium hydroxide and polyacrylamide. The synthesis commences with preparation of a medium comprising a polyacrylamide solution. The polyacrylamide solution is prepared by adding a predetermined amount of polyacrylamide to deionized water and stirring the solution in a range from 800 to 900 rpm. This polyacrylamide solution functions as a medium for hydrolysis of tetraethyl orthosilicate. In an exemplary embodiment of the present invention, the concentration of polyacrylamide solution is in a range from 200 to 1000 ppm to facilitate stable nanoparticle dispersion.

The synthesis further comprises adding a pre-determined volume of the precursor such as tetraethyl orthosilicate under stirring condition to the polyacrylamide solution. In various embodiment of the present invention, the volume of precursor varies depending on desired concentration of silica nanofluid and scale of synthesis. In an exemplary embodiment of the present invention, the pre-determined volume is in a range from 30 to 150 ml for 1000 ml of silica nanofluid. In an embodiment of the present invention, the tetraethyl orthosilicate is added at a flow rate in a range from 0.5 to 1 ml/min at an interval of 15 minutes after every 25% incremental addition of the pre-determined volume of tetraethyl orthosilicate. This gradual addition of tetraethyl orthosilicate facilitates uniform mixing and effective hydrolysis.

In an exemplary embodiment of the present invention, the concentration of tetraethyl orthosilicate is in a range from 0.14 to 0.70 mol/L. The concentration of tetraethyl orthosilicate is crucial for inducing and regulating the growth of silica nanoparticles. In an embodiment of the present invention, tetraethyl orthosilicate functions as the precursor inducing growth of silica nanoparticles, through a hydrolysis and condensation reaction in the presence of the medium and accelerator. During hydrolysis, tetraethyl orthosilicate undergoes the replacement of ethoxy (−OC₂H₅) groups with hydroxyl (—OH) groups, forming silanol (—Si—OH) intermediates. These silanol groups then undergo condensation, creating siloxane (—Si—O—Si—) bonds that lead to the nucleation and growth of silica nanoparticles.

The synthesis further comprises adding a pre-determined volume of solvent such as ethanol to the solution. In an embodiment of the present invention, ethanol is introduced after every 25% incremental addition of tetraethyl orthosilicate solution. This sequential addition of ethanol is repeated throughout the addition of the entire pre-determined volume of tetraethyl orthosilicate to obtain a mixture. The synthesis further comprises heating the mixture at a predetermined temperature for a duration of 20 to 40 minutes. Advantageously, this sequential addition of tetraethyl orthosilicate and ethanol promotes optimal reaction conditions and aids in the formation of the nanoparticles. Ethanol enhances miscibility of tetraethyl orthosilicate with polyacrylamide solution. Alternate addition of ethanol and tetraethyl orthosilicate is essential for complete hydrolysis of tetraethyl orthosilicate in polyacrylamide solution. In an exemplary embodiment of the present invention, the synthesis comprises heating the mixture at a predetermined temperature in a range from 50° C. to 80° C. for a duration of 30 minutes. Advantageously, this heating is essential for promoting the reaction and ensuring the proper formation of the nanoparticles. Heating is carried out to increase the condensation rate and to control the size of nanoparticles grown. At lower temperatures in a range from 50-60° C., smaller nanoparticles are formed. At higher temperatures in a range from 70-80° C., larger particles are formed. Heating is also crucial in complete and faster hydrolysis of tetraethyl orthosilicate.

The synthesis further comprises of addition of a pre-determined volume of the accelerator such as ammonium hydroxide to the mixture over a duration of 15 minutes. In various embodiment of the present invention, the volume of accelerator varies depending on the scale of synthesis. In an exemplary embodiment of the present invention, the pre-determined volume of ammonium hydroxide is in a range from 15 to 30 ml for 1000 ml nanofluid. Subsequently, the mixture is stirred for a duration of 30 minutes to obtain the size-controlled silica nanoparticles.

In an exemplary embodiment of the present invention, the concentration of ammonium hydroxide is in a range from 0.25 to 0.91 mol/L. In another exemplary embodiment of the present invention, 25% ammonium hydroxide is used to maintain a pH in a range of 8 to 9. The concentration of ammonium hydroxide is crucial for controlling nucleation and preventing aggregation of the nanoparticles.

In an embodiment of the present invention, ammonium hydroxide is added to accelerate the growth of silica nanoparticles. Ammonium hydroxide catalyses the condensation reaction of orthosilicate, tetraethyl thereby expediting nanoparticle formation while ensuring uniform size and dispersion stability. By increasing the pH of the reaction medium to an alkaline range, ammonium hydroxide enhances the breakdown of tetraethyl orthosilicate into silanol (—Si—OH) groups, which then undergoes rapid condensation to form siloxane (—Si—O—Si—) bonds, leading to controlled nanoparticle growth. In an embodiment of the present invention, the concentration of ammonium hydroxide influences the particle size. Higher concentrations of ammonium hydroxide may promote smaller, monodisperse nanoparticles (5-100 nm) due to faster condensation, while lower concentrations of ammonium hydroxide may result in larger particle formation.

In an embodiment of the present invention, the hydrolysis reaction results in the formation of silica nanoparticles, which remain dispersed in the solution (silica nanofluid) without agglomeration. The process of the present invention ensures precise control of size of nanoparticle, making it superior to conventional multi-step methods that often suffer from particle agglomeration and inconsistent dispersion. In an embodiment of the present invention, the particle size of silica nanoparticles in the silica nanofluid is controlled in a range from 5-300 nm.

Advantageously, in an embodiment of the present invention, the silica nanofluid exhibits a high zeta potential in a range from −46 to −38 mV. High zeta potential values indicate strong electrostatic repulsion, which prevents the particle aggregation thereby maintaining a stable colloidal dispersion. The high zeta potential confers long-term colloidal stability, with no agglomeration observed even after prolonged storage. In an embodiment of the present invention, the silica nanofluid remains stable for at least three months without agglomeration. This long-term stability is crucial for controlling nanoparticle size which prevents the need for frequent agitation for dispersion of nanoparticles. Proper dispersion of nanoparticles in base fluid leads to enhanced compressive strength of oil-well cement, reduced permeability and porosity by blocking micro-channels, and mitigating shale swelling by limiting water ingress, thereby improving cement-formation bonding. This long-term stability also eliminates the need for additional stabilizing agents, making the process more cost-effective for industrial applications.

### Preparation of Base Fluid

In an embodiment of the present invention, a predetermined amount of solution comprising silica nanoparticles is mixed with water under stirring conditions to obtain a base fluid. In an exemplary embodiment of the present invention, the concentration of silica nanoparticles in the predetermined amount of the solution is 1-5 wt %. The silica nanoparticles are uniformly dispersed in the base fluid.

### Preparation of Oil-Well Cement Slurry

In an embodiment of the present invention, oil-well cement is gradually added to the base fluid to form a homogeneous oil-well cement slurry. In an exemplary embodiment of the present invention, the cement is selected from a group comprising API classes of cement used in oil and gas. In an embodiment of the present invention, class G oil well cement is used to prepare cement slurry. In an exemplary embodiment of the present invention, for preparation of cement slurry, 100 gm of class G cement is added to a base fluid comprising 42.5 g of water and 2.5 g of the solution comprising silica nanoparticles, making ratio of cement to base fluid to be 100:45. In various embodiments of the present invention, the amount of base fluid may be increased or decreased as per well bore requirements.

In an embodiment of the present invention, the cement slurry prepared with base fluid having size-controlled silica nanoparticles exhibits enhanced compressive strength and durability. When introduced into the oil-well cement slurry, the silica nanoparticles significantly enhance cement performance by reducing porosity and permeability, blocking fluid ingress, and acting as nucleation sites for hydration products, leading to a 48% increase in compressive strength.

In an embodiment of the present invention, the process of preparing oil-well cement slurry comprising size-controlled silica nanoparticles is highly scalable and suitable for industrial applications in oil-well cementing across various drilling environments. The process of the present invention eliminates the need for expensive commercial nanoparticle additives. The present invention also reduces material costs and operational complexity, making it economically viable for large-scale oilfield applications.

In an embodiment of the present invention, a composition of an oil-well cement slurry comprising size-controlled silica nanoparticles is provided. The oil-well cement slurry comprises cement, water, silica nanoparticles and one or more additives. In an exemplary embodiment, the additives include expanding additives, multifunctional cement additive, defoamer, fluid loss agent, non retarding fluid loss agent, dispersant and retarder. The size of silica nanoparticles in the oil-well cement slurry is in a range from 5 to 300 nm. This uniform particle size distribution significantly improves the performance of the cement slurry.

Advantageously, the silica nanofluid of present invention exhibits uniform dispersion and greater control over size. This silica nanofluid disperses over entire cement matrix and fill the voids thereby, reducing porosity and permeability. Due to uniform dispersion of nanoparticles in cement matrix, these silica nanoparticles also provide additional nucleation sites upon which hydration products are deposited. This results in increasing compressive strength of cement. Also, silica nanoparticles tend to form a barrier which reduces the fluid loss from cement slurry and helps inhibiting shale swelling. By altering the silica concentration of nanofluid and base fluid, desired mechanical properties in oil-well cement is attained.

In various embodiments of the present invention, the oil-well cement slurry size-controlled silica comprising nanoparticles exhibits a surprising positive effect of an increased compressive strength by approximately 488. The cement slurry comprising size-controlled silica nanoparticles exhibits compressive strength of 3661 psi, whereas conventional oil-well cement slurry exhibits compressive strength of 2467 psi under same conditions. In an embodiment of the present invention, the increase in compressive strength is attributed to the fact that silica nanoparticles effectively fill micro-voids and nano-channels within the cement matrix, reducing porosity and permeability.

The oil-well cement slurry comprising size-controlled silica nanoparticles also exhibits significant improvement in fluid-loss control and wellbore integrity, making it suitable for deep and high-pressure environments. In conventional oil-well cement, fluid loss through occurs micro-channels and interconnected pores, leading to a weak and permeable cement structure. The inclusion of size-controlled silica nanoparticles in the cement slurry blocks these channels, reduces porosity thereby preventing excessive fluid migration. This ensures proper cement setting and hydration, reducing the risk of well failure. In an embodiment of the present invention, the oil-well cement slurry comprising size-controlled silica nanoparticles exhibits enhanced long-term stability, maintaining its dispersion properties even after extended storage periods.

Furthermore, the oil-well cement slurry comprising size-controlled silica nanoparticles minimizes shale swelling by restricting water penetration into formations, thereby improving wellbore integrity and cement-formation bonding. In addition to higher compressive strength, the oil-well cement slurry also exhibits improved resistance to downhole conditions compared to conventional cement formulations.

The process of the present invention overcomes limitations of conventional methods by ensuring uniformly dispersed silica nanoparticles in the base fluid before addition of the cement. By controlling the concentration of precursor and accelerator, the process precisely regulates the growth and size of nanoparticles. Since the nanoparticles are synthesized during the hydrolysis reaction with polyacrylamide, they remain in a colloidal suspension rather than forming dry clusters, preventing agglomeration. The high zeta potential of the synthesized silica nanoparticle solution further ensures long-term stability and electrostatic repulsion, preventing particles from clumping together even after three months of storage.

Conventionally, porosity nature reduces overall compactness and durability in cement and leaves significant space or voids to be taken by foreign fluid or water molecules, when they come in contact. Further, porous cements fail to bond properly with the formation, and it leads to weak casing support and potential risk of fluid migration from formation. Porosity in cement compromises the ability to form a solid impermeable seal, which is essential for long-term performance and safety of casing. Advantageously, in the present invention, the well-dispersed nanoparticles fill micro voids within the cement matrix, reducing porosity and permeability, which in turn minimizes fluid ingress and improves structural integrity. Additionally, the nanoparticles act as nucleation sites for hydration reactions, accelerating calcium silicate hydrate (C—S—H) gel formation, which is responsible for the strength development in cement. Further, the synthesis of silica nanoparticles in accordance with present invention synthesizes nanoparticles in polyacrylamide medium. Inclusion of such nanoparticles in oil-well cement will uniformly distribute them to interact with calcium silicate hydrates, which is the limitation in conventional oil-well cement prepared by mixing of commercial powdered silica nanoparticles.

Further, oil-well cement prepared in accordance with the present invention offers enhanced adaptability and effectiveness in wellbore applications, particularly during completion operations. Conventional oil-well cement containing nanoparticles of a single particle size may not be suitable for various formation types, such as shale, due to challenges like filter cake formation and fluid-loss. Shale formations, in particular, exhibit significant variation in grain size and morphology with depth, necessitating nanoparticles tailored to match these changing characteristics.

A single, fixed particle size is often incompatible with the diverse grain sizes encountered in shale. Advantageously, in the oil-well cement prepared in accordance with the present invention, the particle sizes of silica nanoparticles can be engineered to match the grain size of the target shale, ensuring optimal compatibility and performance. As such, when used in shale formation, the oil-well cement prepared in accordance with the present invention promotes the formation of effective filter cake, which significantly improves fluid-loss control and mitigates shale swelling. The silica nanoparticles in cement slurry of the present invention, due to their compatible size, efficiently fill the pores on the shale surface-something not achievable with conventional commercial nanoparticles.

Additionally, oil-well cement prepared in accordance with the present invention remains stable against agglomeration, settling, and phase separation during storage at the well site. This stability reduces the need for frequent mixing and associated infrastructure, resulting in cost savings for the industry.

Moreover, the controlled size of the nanoparticles in the composition ensures compatibility with varying grain sizes of shale formations encountered at different depths in oil wells. This allows the oil-well cement slurry of the present invention to provide a better bond between the cement and formation, preventing shale swelling caused by water ingress and enhancing wellbore stability. Overall, the process of the present invention provides an oil-well cement slurry having superior performance compared to oil-well cement slurry prepared by conventional methods, thereby making it a more effective solution for oil-well cementing applications.

### WORKING EXAMPLES

### Example 1

### Synthesis of Silica Nanofluid Comprising Size-Controlled Silica Nanoparticles

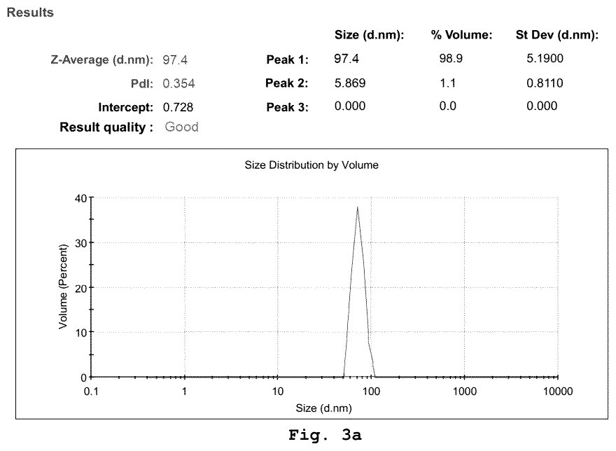

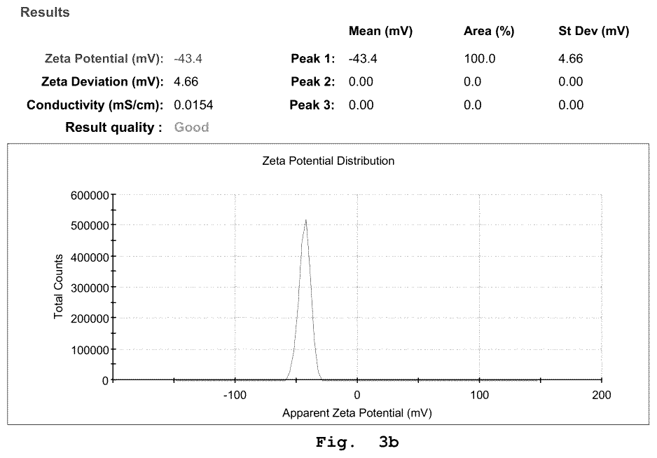

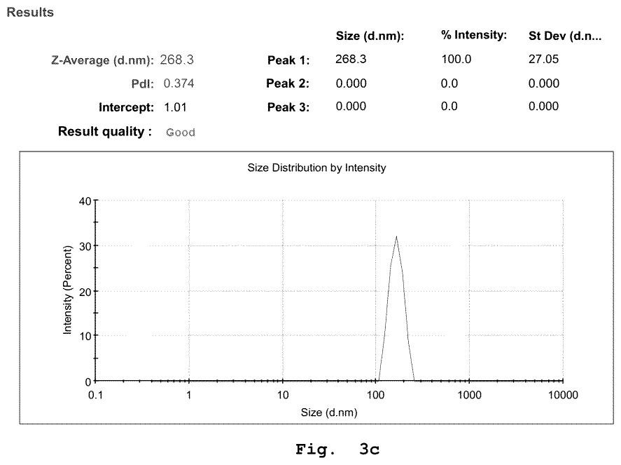

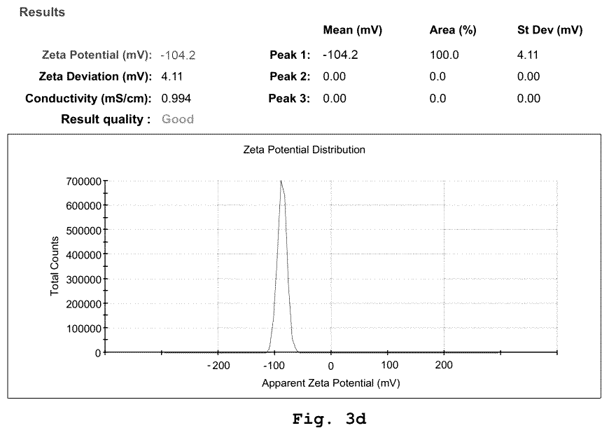

To 800 ml of deionized water, 0.8 gm of polyacrylamide granules was added to prepare polymer solution of concentration 1000 ppm and stirred at 800-900 rpm for a duration of 7-8 hours. To obtain 1 wt % silica nanofluid, 30 ml of tetraethyl orthosilicate was added dropwise at a flowrate of 1 ml/min to the polyacrylamide solution. After addition of 10 ml of the total volume, the dropwise addition is paused. Subsequently 50 ml of ethanol was added dropwise and stirred. Following the addition of ethanol, 10 ml of tetraethyl orthosilicate was added dropwise at a flowrate of 1 ml/min to the polyacrylamide solution. Subsequently, 50 ml of ethanol was added dropwise and stirred. The solution mixture was subsequently heated at a temperature of 50-60° C. for a duration of 30 minutes. After the completion of heating, 25 ml of 25% ammonium hydroxide was added at a flow rate of 1 ml/min for a duration of 15 minutes. The particle size of synthesized silica nanoparticles was in a range from 90-100 nm, as shown in FIG. 3a.

### Zeta Potential

Zeta potential values are a measure of stability of nanoparticles in suspension. Zeta potential is the electrical potential difference between nanoparticle surface and base fluid. Zeta potential values greater than-30 mV denotes that nanofluid is stable and there will be no aggregation and sedimentation over the period of time. The zeta potential of ICS-A1 was −43.4 mV as shown in FIG. 3b.

### Preparation of Base Fluid

2.5 gm of silica nanofluid was mixed with 42.5 gm of water under stirring conditions to obtain a base fluid of water-nanofluid mixture and silica nanoparticles uniformly dispersed in it. The concentration of silica nanoparticles in the solution was in a range from 1 to 5 wt %.

### Preparation of Oil-Well Cement Slurry

100 gm gm of oil-well cement class G was gradually added to the 45 gm of base fluid comprising 42.5 gm of water and 2.5 gm of silica nanofluid, under constant stirring to obtain a homogeneous oil-well cement slurry. The ratio of cement to water in the oil-well cement slurry was 100:45.

### Characterization of Oil-Well Cement Slurry

Cement blocks/plugs were prepared with oil-well cement slurry prepared in accordance with example 1 (hereinafter referred to as “ICS-A1”) and cured at 109° C. and 3000 psi pressure. The cured cement blocks were further evaluated for compressive strength, permeability, porosity and swelling and compared with cement blocks prepared with conventional oil-well cement slurry (hereinafter referred to as “REF-X1”).

### Evaluation of Permeability

Core-flooding experiments were carried out using the cement plugs to understand the nature and permeability of cement in the plugs. CO₂ gas was injected into the cement plugs visualize permeable nature of cement plugs. The permeable nature of cement was assessed by the pressure generated during gas injection in cement plugs in core flooding. The plug prepared from REF-X1 exhibited a peak pressure of 16 psi which suggested the presence of channels for gas migration. However, cement plugs prepared with ICS-A1 exhibited peak pressure of 293 psi after injecting 250 ml of CO₂, which suggested that the presence of silica nanoparticles significantly reduced the permeability of cement plug.

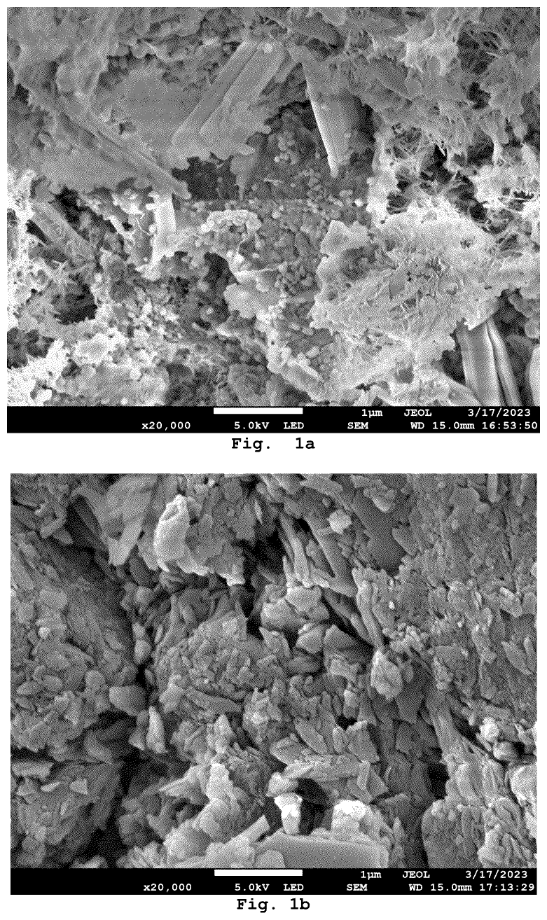

This was further evidenced by the FE-SEM image (FIG. 1a) of cement plug prepared with ICS-A1, which shows that silica nanoparticles have been uniformly distributed in cement matrix. FIG. 1b is the FE-SEM image of cement plus prepared with REF-X1 where gaps and voids are prominently visible. The permeability reduction in the plug prepared from ICS-A1 was due to the particle size of silica nanoparticles, which was uniformly distributed in the cement matrix thereby remaining in the matrix to interact with cement and reach to every possible void in cement, as shown in FIG. 1a.

### Evaluation of Porosity

Porosity of the cement plugs was measured through Helium—porosimeter. Helium porosimeter consists of matrix cell (sample cell) and reference cell and it uses Boyle's law to measure grain volume. The length of plug, diameter, and pressure (via Helium—Porosimeter) were measured to determine pore volume and grain volume. The pressure sensor monitors the pressure inside both sample and reference cell. The pore volume was determined by isothermal helium expansion through application of Boyle's law and Charles' law. Porosity (Φ) is calculated by following relation:

$$Φ = Pore volume / Bulk volume$$

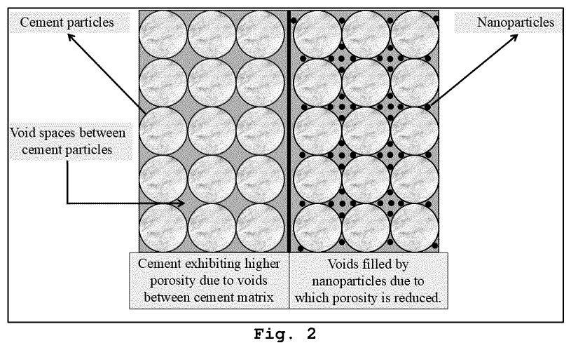

The porosity of hydrated plugs made from REF-X1 was measured as 15.27%, whereas the plugs prepared from ICS-A1 was measured at 3.7%. This indicated that a significant reduction in porosity of around 75% in cement plugs prepared from ICS-A1. FIG. 2 shows the comparison of pore space in cement plugs prepared from REF-X1 and ICS-A1. As seen in FIG. 2, cement plug prepared from ICS-A1 does not show any voids or porosity for the absorption of water, which also brings solidity to the cement.

### Evaluation of Swelling and Fluid Loss

Shale swelling and fluid-loss are very important issues in wellbore during placement of cement slurry against shale, as the important task of cementing. Shale swelling is the result of water interaction with clay minerals in shale, and it can be controlled if water does not pass through the nanoparticle layer. In addition, shale exhibits different grain size and single particle size cannot work and makes impermeable layer against different grains in shale.

Fluid loss from cement was reduced by around 24% with inclusion of silica nanofluid as slurry without nanofluid showed fluid loss of 38 ml after 30 minutes which reduced to 29 ml in case of slurry with nanofluid. Fluid loss of ICS-A1 sample was 29 ml and that of REF-X1 was 38 ml, and therefore there was a reduction of 9 ml in fluid loss which is around 24%. Further, the swelling of shale was found to be reduced by up to 13% by the cement prepared from ICS-A1.

### Evaluation of Compressive Strength

The compressive strength of cement block prepared from REF-X1 was found to be 2467 psi, cured at 109° C. and at a pressure of 3000 psi. Whereas compressive strength of cement block prepared from ICS-A1 increased to 3661 psi after 72 hrs, thereby evidencing an increase of about 48% in compressive strength of cement.

### Example 2

### Synthesis of Silica Nanofluid Comprising Size-Controlled Silica Nanoparticles

To prepare 1000 ml of 5 wt % silica nanofluid, in 500 ml DI water, 235 gm of sodium metasilicate nonahydrate was added and stirred at 500 rpm. After 30 min, acetic acid was added dropwise until pH reached 5. Water was added to get 1000 ml. After that, the suspension was stirred for 5-6 hours, 0.2 to 1 gm of polyacrylamide granules was added, and was allowed to stir for next 5-6 hours. The particle size of synthesized silica nanoparticles was in a range from 200-300 nm. The zeta potential of prepared silica nanofluid varied with concentration of polyacrylamide from −60 to −110 mV. The particle size of silica nanoparticles in the silica nanofluid was 268.3 nm and zeta potential was −104.4 mV. FIGS. 3c and 3d illustrate particle size and zeta potential graph of nanofluid prepared with 500 ppm polyacrylamide.

### Zeta Potential

The zeta-potential of the silica nanofluid prepared with varying concentration of polyacrylamide in accordance with example 2 is provided in Table 1. As seen from Table 1, the zeta potential of sample N1 (with 200 ppm polyacrylamide) was −69.5 mV and that of sample N2 (with 500 ppm polyacrylamide) was −104.2 mV, which suggested that nanofluid were highly stable.

TABLE 1
Size and zeta potential of 5 wt % nanofluid.

| Sample | Size (nm) | Zeta potential (mV) |
|---|---|---|
| N1 (200 ppm) | 303 | −69.5 |
| N2 (500 ppm) | 268 | −104.2 |

### Preparation of Base Fluid

2.5 gm of silica nanofluid was mixed with 42.5 gm of water under stirring conditions to obtain a base fluid. The concentration of silica nanoparticles in the solution was in a range from 1 to 5 wt %.

### Preparation of Oil-Well Cement Slurry

100 gm gm of oil-well class-G cement was gradually added to the 45 gm of base fluid comprising 42.5 gm of water and 2.5 gm of silica nanofluid, under constant stirring to obtain a homogeneous oil-well cement slurry. The ratio of cement to base fluid in the oil-well cement slurry was 100:45.

### Characterization of Oil-Well Cement Slurry

Cement blocks/plugs were prepared with oil-well cement slurry prepared in accordance with example 2 (hereinafter referred to as “ICS-A2”) and cured at 109° C. and 3000 psi pressure. The cured cement blocks were further evaluated for compressive strength, permeability, porosity and swelling and compared with cement blocks prepared with conventional oil-well cement slurry (hereinafter referred to as “REF-X2”).

### Evaluation of Compressive Strength

The cement blocks prepared with ICS-A2 and REF-X2 were cured at a temperature of 109° C. and the pressure was 3000 psi. The compressive strength of cement blocks made from REF-X2 was 2467 psi. The compressive strength of ICS-A2 was found to be 3474 psi, showing a 40% increase in compressive strength.

### Evaluation of Swelling and Fluid Loss

The fluid loss of cement slurry REF-X2 was 38 ml and that of ICS-A2 was 31 ml showing that fluid loss decreased by 7 ml i.e., 18% decrement.

### Evaluation of Permeability

Permeability of cement samples were indirectly measured by pressure rise on injecting CO₂ in cement plug. The pressure rose to 276 psi with cement samples prepared with ICS-A2.

### Evaluation of Porosity

Porosity of cement plugs made from REF-X2 and ICS-A2 were measured from Helium-porosimeter. Porosity of cement plugs made from ICS-A2 was found to be 7% and that of cement plugs made from REF-X2 was 15.27%.

While the exemplary embodiments of the present invention are described and illustrated herein, it will be appreciated that they are merely illustrative. It will be understood by those skilled in the art that various modifications in form and detail may be made therein without departing from the scope of the invention.

We claim:

1. A process for preparing an oil-well cement slurry, the process comprising:
(a) hydrolysing a precursor and an accelerator in a medium to obtain a colloidal suspension of silica nanofluid comprising size-controlled silica nanoparticles, wherein the hydrolysis comprises the steps of:
adding a predetermined volume of the precursor to the medium at a predetermined flow rate and at a predetermined interval for every 25% incremental addition of the predetermined volume of the precursor;
adding a solvent dropwise after every 25% incremental addition of the predetermined volume of precursor to the medium to obtain a mixture;
heating the mixture at a predetermined temperature for a predetermined duration;
adding a predetermined volume of the accelerator dropwise for a predetermined duration to the mixture to obtain a colloidal suspension of silica nanofluid comprising size-controlled silica nanoparticles having a particle size in a range from 5-300 nm;
(b) adding a predetermined amount of water to silica nanofluid to obtain a base fluid; and
(c) adding cement to the base fluid at a cement to base fluid ratio of 100:45 to obtain an oil-well cement slurry comprising size-controlled silica nanoparticles.

2. The process as claimed in claim 1, wherein the precursor is selected from a group consisting of tetraethyl orthosilicate and sodium metasilicate nonahydrate.

3. The process as claimed in claim 2, wherein a concentration of tetraethyl orthosilicate is in a range from 0.14 to 0.70 mol/L.

4. The process as claimed in claim 2, wherein a concentration of sodium metasilicate nonahydrate is in a range from 0.16 to 0.83 mol/L.

5. The process as claimed in claim 1, wherein the accelerator is ammonium hydroxide.

6. The process as claimed in claim 5, wherein a concentration of ammonium hydroxide is in a range from 0.25 to 0.91 mol/L.

7. The process as claimed in claim 5, wherein the process comprises using 25% ammonium hydroxide to maintain a pH in a range from 8 to 9.

8. The process as claimed in claim 1, wherein the medium is a polyacrylamide solution having a concentration in a range from 200 to 1000 ppm.

9. The process as claimed in claim 1, wherein the solvent is ethanol.

10. The process as claimed in claim 8, wherein the polyacrylamide solution is prepared by adding a predetermined amount of polyacrylamide to deionized water and stirring the polyacrylamide solution in a range from 800 to 900 rpm.

11. The process as claimed in claim 1, wherein the pre-determined volume of the precursor is in a range from 30 to 150 ml.

12. The process as claimed in claim 1, wherein the precursor is introduced at the pre-determined flow rate in a range from 0.5 to 1 ml/min and at the pre-determined interval of 15 minutes for every 25% incremental addition of the pre-determined volume.

13. The process as claimed in claim 1, wherein the predetermined volume of the accelerator is added dropwise for a predetermined duration of 15 minutes to the mixture.

14. The process as claimed in claim 1, wherein the mixture is heated at a temperature in a range from 50° C. to 80° C. for a duration of 30 minutes.

15. The process as claimed in claim 1, wherein the pre-determined volume of accelerator is in a range from 15 to 30 ml for 1000 ml nanofluid.

16. An oil-well cement slurry comprising: cement, water, and size-controlled silica nanoparticles, wherein the size-controlled nanoparticles are synthesised by hydrolysing tetraethyl orthosilicate in a polyacrylamide solution in the presence of ammonium hydroxide, and wherein the cement to base fluid ratio is 100:45, and wherein a particle size of silica nanoparticles is in a range from 5-300 nm.

17. The oil-well cement slurry as claimed in claim 16, wherein the oil-well cement slurry comprising the size-controlled silica nanoparticles exhibits a high zeta potential in a range from −46 to −38 mV.
